(19) United States
(12) Patent Application Publication
(10) Pub. No.: US 2023/0325709 A1
(43) Pub. Date: Oct. 12, 2023

(54) EMBEDDING TABLE GENERATION METHOD AND EMBEDDING TABLE CONDENSATION METHOD

(71) Applicant: NEUCHIPS CORPORATION, Hsinchu City (TW)

(72) Inventors: Ching-Yun Kao, Taipei City (TW); Yu-Da Chu, Hsinchu County (TW); Juinn-Dar Huang, Hsinchu County (TW)

(73) Assignee: NEUCHIPS CORPORATION, Hsinchu City (TW)

(21) Appl. No.: 17/748,048

(22) Filed: May 19, 2022

(30) Foreign Application Priority Data
Apr. 7, 2022 (TW) 111113221

(51) Int. Cl. G06N 20/00

(52) U.S. Cl. CPC G06N 20/00

(57) ABSTRACT

An embedding table generation method and an embedding table condensation method are provided. The embedding table generation method includes: building an initial architecture of an embedding table corresponding to categorical data according to an initial feature dimension; performing model training on the embedding table with the initial architecture to generate initial content of the embedding table; computing a condensed feature dimension based on the initial content of the embedding table; building a new architecture of the embedding table according to the condensed feature dimension; and performing the model training on the embedding table with the new architecture to generate condensed content of the embedding table.

### CROSS-REFERENCE TO RELATED APPLICATION

This application claims the priority benefit of Taiwan application serial no. 111113221, filed on Apr. 7, 2022. The entirety of the above-mentioned patent application is hereby incorporated by reference herein and made a part of this specification.

### BACKGROUND

### Technical Field

The disclosure relates to machine learning/deep learning, and in particular relates to an embedding table generation method and an embedding table condensation method for recommending a model in deep learning.

### Description of Related Art

Deep learning/machine learning is widely used in the field of artificial intelligence. In deep learning, a recommendation system may, for example, recommend audio and video streams based on the personal information and historical data of a user. The recommendation system has multiple embedding tables, and each of the embedding tables includes multiple indexes and at least one feature. The lower the number of features (the smaller the feature dimension), the lower the amount of data in the embedding table. Generally speaking, the higher the number of features in the embedding table (the larger the feature dimension), the higher the precision of the recommendation system. However, in some applications, when the number of features in the embedding table is too high (the feature dimension is too large), the recommendation system may be over-fitting, which reduces the precision. The amount of data in the embedding table is usually very high, so the embedding table requires data compression. Without reducing the precision of the recommendation system, how to condense/compress the embedding table to reduce the amount of data is one of the many technical issues in the field of artificial intelligence.

### SUMMARY

The disclosure provides an embedding table generation method and an embedding table condensation method, to generate an embedding table with a suitable feature dimension.

An embodiment of the disclosure provides an embedding table generation method. The embedding table generation method includes the following steps. An initial architecture of an embedding table corresponding to categorical data is built according to an initial feature dimension. Model training is performed on the embedding table with the initial architecture to generate initial content of the embedding table. A condensed feature dimension is computed based on the initial content of the embedding table. A new architecture of the embedding table is built according to the condensed feature dimension. The model training is performed on the embedding table with the new architecture to generate condensed content of the embedding table.

An embodiment of the disclosure provides an embedding table condensation method. The embedding table condensation method includes the following steps. Initial content of an embedding table with an initial feature dimension is received. A condensed feature dimension is computed based on the initial content of the embedding table. A new architecture of the embedding table is built according to the condensed feature dimension. Model training is performed on the embedding table with the new architecture to generate condensed content of the embedding table.

Based on the above, some embodiments of the disclosure may calculate the condensed feature dimension (suitable feature dimension) based on the initial content of the embedding table, and then rebuild a new architecture of the embedding table according to the condensed feature dimension. The embedding table with the new architecture may be model trained again to generate the condensed content of the embedding table. That is, the embodiment may determine the suitable feature dimension of the embedding table through model training, thereby taking into account the precision of the recommendation system as well as the amount of data of the embedding table.

In order to make the above-mentioned features and advantages of the disclosure comprehensible, embodiments accompanied with drawings are described in detail below.

### BRIEF DESCRIPTION OF THE DRAWING

FIG. 1 is a schematic diagram of an embedding table according to an embodiment of the disclosure.

FIG. 2 is a schematic diagram of an embedding table generation method according to an embodiment of the disclosure.

FIG. 3 is a schematic flowchart of an embedding table generation method according to an embodiment of the disclosure.

FIG. 4 is a flowchart of an embedding table generation method according to an embodiment of the disclosure.

FIG. 5 is a flowchart of an embedding table condensation method according to an embodiment of the disclosure.

### DETAILED DESCRIPTION OF DISCLOSED EMBODIMENTS

The term “coupled (or connected)” as used throughout this specification (including the scope of the application) may refer to any direct or indirect means of connection. For example, if it is described in the specification that a first device is coupled (or connected) to a second device, it should be construed that the first device may be directly connected to the second device, or the first device may be indirectly connected to the second device through another device or some type of connecting means. In addition, wherever possible, elements/components/steps with the same reference numerals in the drawings and embodiments represent the same or similar parts. Elements/components/steps that use the same reference numerals or use the same terminology in different embodiments may refer to relevant descriptions of each other.

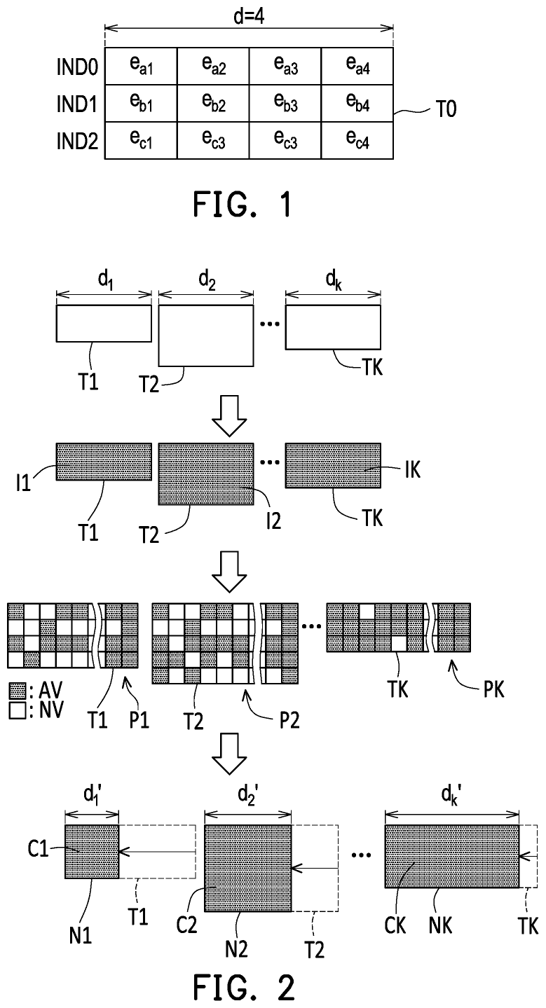

FIG. 1 is a schematic diagram of an embedding table according to an embodiment of the disclosure. In deep learning, a recommendation system may include multiple embedding tables. Referring to FIG. 1, for example, an embedding table T0 among the multiple embedding tables may include three indexes, i.e. an index IND0, an index IND1, and an index IND2. Each of the indexes includes 4 features, for example, the index IND0 includes a feature eₐ₁, a feature eₐ₂, a feature eₐ₃, and a feature eₐ₄, the index IND1 includes a feature e_{b1}, a feature e_{b2}, a feature e_{b3}, and a feature e_{b4}, and the index IND2 includes a feature e_{c1}, a feature e_{c2}, a feature e_{c3}, and a feature e_{c4}. In other words, in this embodiment, the number of indexes of the embedding table T0 is 3, and a feature dimension d is 4. It must be noted that the embedding table T0 is only an example, and the disclosure does not limit the number of embedding tables in the recommendation system, the number of indexes of each of the embedding tables, and the feature dimension of each of the embedding tables.

It must be noted that the recommendation system of the disclosure may be constructed by an artificial neural network (ANN). The relevant functions of the recommendation system may be implemented by programming codes such as general programming languages (such as C, C++, or combinational languages) or other suitable programming languages. The programming code may be recorded or stored in a recording medium, for example, the recording medium includes a read only memory (ROM), a storage device and/or a random access memory (RAM). The programming code may be read and executed from the recording medium by a processor (not shown), to achieve the relevant functions of the recommendation system. The processor may be configured in, for example, a desktop computer, a personal computer (PC), a portable terminal product, a personal digital assistant (PDA), and a tablet PC, etc. In addition, the processor may include a central processing unit (CPU) with image data processing and computing functions, or other programmable general-purpose or special-purpose microprocessor, a digital signal processor (DSP), an image processing unit (IPU), a graphics processing unit (GPU), a programmable controller, an application specific integrated circuit (ASIC), a programmable logic device (PLD), and other similar processing devices, or a combination of these devices. A “non-transitory computer readable medium” may be used as the recording medium, for example, a tape, a disk, a card, a semiconductor memory, or a programming designable logic circuit, etc. Also, the programming code may be supplied to a computer (or CPU) via an arbitrary transmission medium (a communication network or a broadcast wave, etc.). The communication network is, for example, the Internet, a wired communication, a wireless communication, or other communication media.

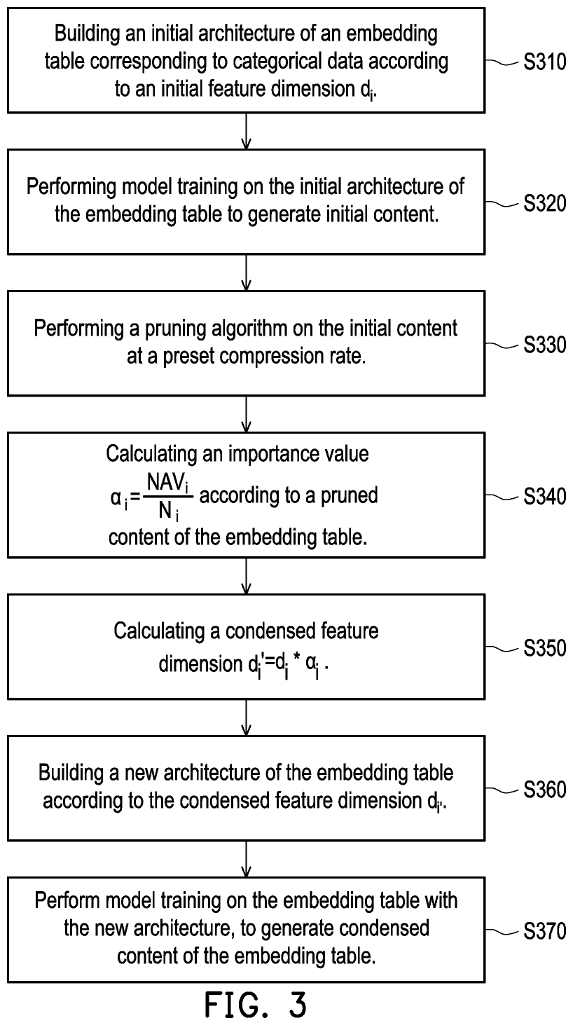

FIG. 2 is a schematic diagram of an embedding table generation method according to an embodiment of the disclosure. FIG. 3 is a schematic flowchart of an embedding table generation method according to an embodiment of the disclosure. Referring to FIG. 2 and FIG. 3 at the same time, in step S310, a processor receives multiple categorical data, and builds an initial architecture of an embedding table corresponding to categorical data according to an initial feature dimension dᵢ. Specifically, the categorical data (of an original data set) is used to provide an artificial neural network to construct multiple embedding tables, each of which may have the same or different initial architecture. For example, the initial architecture of an embedding table T1 includes, for example, M1 columns and U1 rows, M1 columns correspond to an initial feature dimension d₁, and U1 rows correspond to U1 indexes. The initial architecture of an embedding table T2 includes, for example, M2 columns and U2 rows, M2 columns correspond to an initial feature dimension d₂, and U2 rows correspond to U2 indexes. By analogy, the initial architecture of an embedding table TK includes, for example, MK columns and UK rows, MK columns correspond to an initial feature dimension d_{K}, and UK rows correspond to UK indexes. For example, the initial feature dimensions of the embedding table T1, the embedding table T2, and the embedding table TK may all be 128, but the initial feature dimensions of each of the embedding tables may be the same or different, which is not limited thereto.

Next, in step S320, the processor respectively performs model training on the initial architecture of the embedding table T1, the embedding table T2, . . . , and the embedding table TK to generate initial content I1, initial content I2, . . . , and initial content IK. Model training is, for example, a common training method in machine learning/deep learning. For example, the minimum cost function is calculated in an iterative manner according to the training conditions, to obtain a trained initial content, in which the initial content is, for example, a weight value of the artificial neural network, but the disclosure is not limited thereto.

In step S330, the processor performs a pruning algorithm on the initial content of each of the embedding tables at a preset compression rate, to convert the initial content into a pruned content. For example, the processor may perform a pruning algorithm, such as a MinMax algorithm, on the initial content I1, the initial content I2, . . . , and the initial content IK, to respectively generate a pruned content P1, a pruned content P2, . . . , and a pruned content PK, but the disclosure does not limit the multiplication ratio of the preset compression rate and the type of the pruning algorithm. Each of the pruned contents may include multiple non-zero features AV, i.e., features with a non-zero value in the pruned content, and multiple zero features NV, i.e., features with a zero value in the pruned content.

Next, in step S340, the processor calculates the importance value αᵢ of the embedding table Tᵢ according to the pruned content of each of the embedding tables. Specifically, the processor may first count the number of non-zero features AV and the number of total features in each of the pruned contents to obtain a non-zero feature number NAVᵢ and a total feature number Nᵢ. The total feature number Nᵢ may be obtained by summing the non-zero feature number NAVᵢ and the number of zero features NV, but not limited thereto. Next, refer to the equation (1) for the calculation method of the importance value αᵢ:

$${a}_{i} = \frac{{NAV}_{i}}{{N}_{i}} \qquad ( 1 )$$

where NAVᵢ is the non-zero feature number and Nᵢ is the total feature number. For example, an importance value α₁ of the embedding table T1 may be 0.3, an importance value α₂ of the embedding table T2 may be 0.7, and an importance value αₖ of the embedding table TK may be 0.9.

Next, in step S350, the processor may calculate the product of the initial feature dimension dᵢ and the importance value αᵢ as a condensed feature dimension dᵢ′ of each of the embedding tables, as shown in the equation (2):

dᵢ′=dᵢ×aᵢ (2)

For example, assuming that the initial feature dimension d₁ corresponding to the embedding table T1 is 128 and the importance value α₁ is 0.3, the value of the condensed feature dimension d₁′ may be obtained by calculating the product of the initial feature dimension d₁ and the importance value α₁, which is 38. By analogy, a condensed feature dimension d₂′ corresponding to the embedding table T2 is, for example, 90, and a condensed feature dimension d_{K}′ corresponding to the embedding table TK is, for example, 115.

In step S360, the processor may build a new architecture of each of the embedding tables according to the condensed feature dimension dᵢ′ of each of the embedding tables. In this embodiment, the new architecture of the embedding table T1 includes, for example, M1′ columns and U1 rows, and M1′ columns correspond to the condensed feature dimension d₁′. The new architecture of the embedding table T2 includes, for example, M2′ columns and U2 rows, and M2′ columns correspond to the condensed feature dimension d₂′. The new architecture of the embedding table TK includes, for example, MK′ columns and UK rows, and MK′ columns correspond to the condensed feature dimension d_{K}′.

Next, in step S370, the processor may perform model training on each of the embedding tables with the new architecture, to generate condensed content of each of the embedding tables. In this embodiment, the embedding table T1 with a new architecture N1 is model trained to generate condensed content C1. The embedding table T2 with a new architecture N2 is model trained to generate condensed content C2. The embedding table TK with a new architecture NK is model trained to generate condensed content CK. For example, the initial feature dimension d₁ corresponding to the initial content I1 corresponding to the embedding table T1 is 128, the condensed feature dimension d₁′ corresponding to the condensed content C1 of the embedding table T1 is 38, and the data capacity of the condensed content C1 in the embedding table T1 is compressed by 3.37 times compared to the initial content I1. By analogy, the data capacity of the condensed content C2 in the embedding table T2 is compressed by 1.42 times compared to the initial content I2. The data capacity of the condensed content CK in the embedding table TK is compressed by 1.11 times compared to the initial content IK. The model training in step S370 and step S320 may use the same or different training methods, but not limited thereto.

It is worth mentioning that the importance value αᵢ is equivalent to the importance of the features in each of the embedding tables. Taking FIG. 2 as an example, since in the pruned content P1 of the embedding table T1, the proportion of the non-zero features AV is lower and the proportion of the zero features NV is higher, it may be analyzed that the importance of the overall features of the embedding table T1 is lower, which is suitable for a higher compression rate. On the contrary, since in the pruned content PK of the embedding table TK, the proportion of the non-zero features AV is higher and the proportion of the zero features NV is lower, it may be analyzed that the importance of the overall features of the embedding table TK is higher, which is suitable for a lower compression rate. In other words, the compression rate may be adjusted by analyzing the importance of the features in the embedding table, thereby taking into account the precision of the recommendation system and the data compression rate, and reducing the time cost and the hardware cost of training.

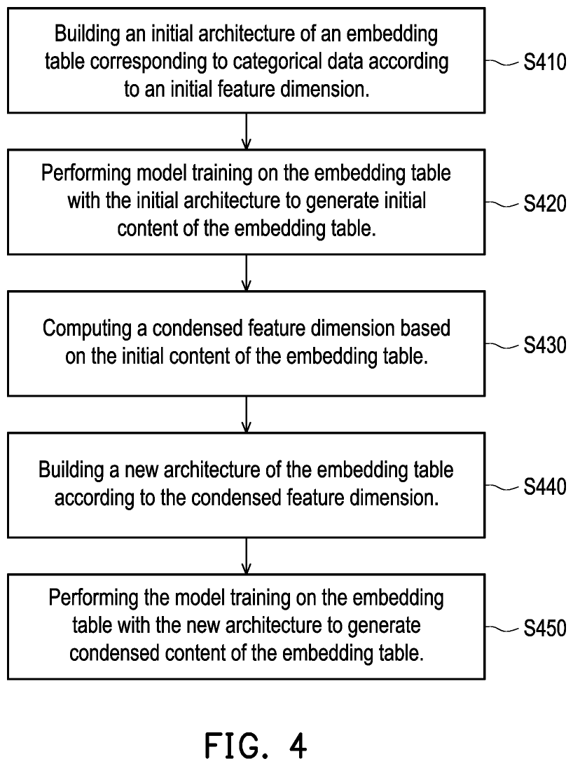

FIG. 4 is a flowchart of an embedding table generation method according to an embodiment of the disclosure. Referring to FIG. 4, in step S410, a processor builds an initial architecture of an embedding table corresponding to categorical data according to an initial feature dimension. In step S420, the processor performs model training on the embedding table with the initial architecture to generate initial content of the embedding table. Next, in step S430, the processor calculates a condensed feature dimension based on the initial content of the embedding table. In step S440, the processor builds a new architecture of the embedding table according to the condensed feature dimension. In step S450, the processor performs model training on the embedding table with a new architecture to generate condensed content of the embedding table.

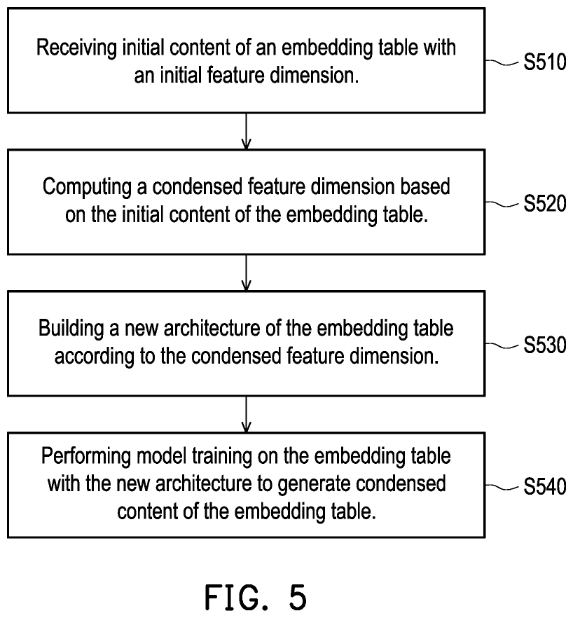

FIG. 5 is a flowchart of an embedding table condensation method according to an embodiment of the disclosure. Referring to FIG. 5, in step S510, a processor receives initial content of an embedding table with an initial feature dimension. Next, in step S520, the processor calculates a condensed feature dimension based on the initial content of the embedding table. In step S530, the processor builds a new architecture of the embedding table according to the condensed feature dimension. Next, in step S540, the processor performs model training on the embedding table with a new architecture to generate condensed content of the embedding table.

To sum up, some embodiments of the disclosure may calculate the condensed feature dimension (suitable feature dimension) based on the initial content of the embedding table, and then rebuild a new architecture of the embedding table according to the condensed feature dimension. The embedding table with the new architecture may be model trained again to generate the condensed content of the embedding table. That is, the embodiment may determine the suitable feature dimension of the embedding table through model training, thereby taking into account the precision of the recommendation system as well as the amount of data of the embedding table, to improve the computing efficiency and save the time cost and the hardware cost of training. On the other hand, the over-fitting problem may be mitigated by reducing the feature dimension.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An embedding table generation method, comprising:
building an initial architecture of an embedding table corresponding to categorical data according to an initial feature dimension;
performing model training on the embedding table with the initial architecture to generate initial content of the embedding table;
computing a condensed feature dimension based on the initial content of the embedding table;
building a new architecture of the embedding table according to the condensed feature dimension; and
performing the model training on the embedding table with the new architecture to generate condensed content of the embedding table.

2. The embedding table generation method according to claim 1, wherein computing the condensed feature dimension comprises:
calculating an importance value of the embedding table based on the initial content; and
calculating the condensed feature dimension of the embedding table according to the importance value.

3. The embedding table generation method according to claim 2, wherein calculating the importance value of the embedding table comprises:
performing a pruning algorithm on the initial content of the embedding table at a preset compression rate, to convert the initial content into a pruned content; and
calculating the importance value of the embedding table based on the pruned content.

4. The embedding table generation method according to claim 3, wherein calculating the importance value of the embedding table further comprises:
calculating a ratio of a non-zero feature number and a total feature number in the pruned content as the importance value.

5. The embedding table generation method according to claim 2, wherein calculating the condensed feature dimension of the embedding table comprises:
calculating a product of the initial feature dimension and the importance value as the condensed feature dimension.

6. An embedding table condensation method, comprising:
receiving initial content of an embedding table with an initial feature dimension;
computing a condensed feature dimension based on the initial content of the embedding table;
building a new architecture of the embedding table according to the condensed feature dimension; and
performing model training on the embedding table with the new architecture to generate condensed content of the embedding table.

7. The embedding table condensation method according to claim 6, wherein computing the condensed feature dimension comprises:
calculating an importance value of the embedding table based on the initial content; and
calculating the condensed feature dimension of the embedding table according to the importance value.

8. The embedding table condensation method according to claim 7, wherein calculating the importance value of the embedding table comprises:
performing a pruning algorithm on the initial content of the embedding table at a preset compression rate, to convert the initial content into a pruned content; and
calculating the importance value of the embedding table based on the pruned content.

9. The embedding table condensation method according to claim 8, wherein calculating the importance value of the embedding table further comprises:
calculating a ratio of a non-zero feature number and a total feature number in the pruned content as the importance value.

10. The embedding table condensation method according to claim 7, wherein calculating the condensed feature dimension of the embedding table comprises:
calculating a product of the initial feature dimension and the importance value as the condensed feature dimension.
